(19) United States
(12) Patent Application Publication
(10) Pub. No.: US 2018/0105735 A1
(43) Pub. Date: Apr. 19, 2018

(54) SELF-SUSPENDING PROPPANTS

(71) Applicant: SELF-SUSPENDING PROPPANT LLC, Chesterland, OH (US)

(72) Inventors: Huaxiang Yang, Sugar Land, TX (US); David S. Soane, Chestnut Hill, MA (US); James Nathan Ashcraft, Jupiter, FL (US); Allison Silverstone, Hillsboro Beach, FL (US)

(21) Appl. No.: 15/782,922

(22) Filed: Oct. 13, 2017

Related U.S. Application Data
(60) Provisional application No. 62/407,611, filed on Oct. 13, 2016.
(60) Provisional application No. 62/428,258, filed on Nov. 30, 2016.

(51) Int. Cl. C09K 8/80; C09K 8/68; E21B 43/267

(52) U.S. Cl. CPC C09K 8/805; E21B 43/267; C09K 8/685

(57) ABSTRACT

Both the inside surface and the outside surface of the hydrogel polymer coating of a self-suspending proppant are surface crosslinked.

### CROSS-REFERENCE TO RELATED APPLICATION

This application claims priority to application Ser. No. 62/407,611 filed Oct. 13, 2016 (15-Pro) as well as application Ser. No. 62/428,258, filed Nov. 30, 2016 (16-Pro). The entire disclosures of both applications are incorporated herein by reference.

### BACKGROUND

In commonly assigned U.S. Pat. No. 9,297,244 (7-US) and U.S. Pat. No. 9,315,721 (4-US), there are described self-suspending proppants which take the form of a proppant substrate particle carrying a coating of a hydrogel polymer. As further described there, these proppants are formulated in such a way that they rapidly swell when contacted with aqueous fracturing fluids to form hydrogel coatings which are large enough to significantly increase the buoyancy of these proppants during their transport downhole yet durable enough to remain largely intact until they reach their ultimate use locations. The disclosures of these earlier patents are incorporated herein by reference in their entireties.

### SUMMARY

We have now found that self-suspending proppants with especially desirable properties can be made by surface crosslinking both the inside surface and the outside surface of the hydrogel polymer coating of the proppant.

Thus, this invention provides a self-suspending proppant comprising a proppant substrate particle and a water-swellable coating made from a hydrogel polymer on the proppant substrate particle, wherein the water swellable coating defines an inside surface on the proppant substrate particle, an outside surface remote from the inside surface and a body section therebetween, wherein both the inside surface and the outside surface have been surface crosslinked.

In addition, this invention also provides an aqueous fracturing fluid comprising an aqueous carrier liquid and the above self-suspending proppant.

In addition, this invention further provides a method for fracturing a geological formation comprising pumping this fracturing fluid into the formation.

### DETAILED DESCRIPTION

### Definitions

For the purposes of this disclosure, “surface crosslinked” in connection with a hydrogel polymer coating on a proppant substrate particle means crosslinking which has occurred at a surface of the coating, which crosslinking is different from the crosslinking that has occurred in the body section of the coating, if any. Normally, surface crosslinking will occur by chemical modification of the hydrogel polymer, either by applying a crosslinking agent to the proppant substrate particle before the hydrogel polymer is applied, thereby crosslinking the inside surface of the coating, or by applying a crosslinking agent to the hydrogel polymer forming the outside surface of the coating before the coating is dried, thereby crosslinking this outside surface.

### Proppant Substrate Particle

As indicated above, the inventive self-suspending proppants takes the form of a proppant substrate particle carrying a coating of a hydrogel polymer.

For this purpose, any particulate solid which has previously been used or may be used in the future as a proppant in connection with the recovery of oil, natural gas and/or natural gas liquids from geological formations can be used as the proppant substrate particle of the inventive self-suspending proppants. In this regard, see our earlier filed applications mentioned above which identify many different particulate materials which can be used for this purpose. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, resin coated sand including sands coated with curable resins as well as sands coated with precured resins, bauxite, ceramic materials, resin coated ceramic materials including ceramics coated with curable resins as well as ceramic coated with precured resins, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8-2.0 g/cc), normal frac sand (density ˜2.65 g/cc), bauxite and high density ceramics (density ˜3-5 g/cc), just to name a few. Resin-coated versions of these proppants, and in particular resin-coated conventional frac sand, are also good examples.

All of these particulate materials, as well as any other particulate material which is used as a proppant in the future, can be used as the proppant substrate particle in making the inventive self-suspending proppants.

### Hydrogel Coating

The inventive self-suspending proppant is made in such a way that
(1) optionally and preferably, it is free-flowing when dry,
(2) it rapidly swells when contacted with its aqueous fracturing fluid,
(3) it forms a hydrogel coating which is large enough to significantly increase its buoyancy during transport downhole, thereby making this proppant self-suspending during this period,
(4) this hydrogel coating is durable enough to maintain the self-suspending character of the proppant until it reaches its ultimate destination downhole.

This can be done, for example, by following the procedures described in the above-noted Ser. No. 62/407,611 (15-Pro), Ser. No. 62/428,258 (16-Pro), U.S. Pat. No. 9,297,244 (7-US) and U.S. Pat. No. 9,315,721 (4-US). In addition, the procedures described in commonly-assigned U.S. 2014/0228258 (10-US) and Ser. No. 15/595,722, filed May 15, 2017 (14-US) can also be used. The disclosures of these additional applications and patents are also incorporated herein by reference in their entireties.

As mentioned there, the water-swellable coatings of the self-suspending proppants described there can be made from a wide variety of different hydrogel polymers including anionic hydrogel polymers, cationic hydrogel polymers, nonionic hydrogel polymers, combinations of these polymers such as the combination of a cationic hydrogel polymer and an anionic hydrogel polymer or the combination of a cationic hydrogel polymer and an anionic hydrogel polymer. Acrylamide polymers and copolymers as well as various different starches are especially interesting.

As further described there, such self-suspending proppants are normally formulated so that the amount of hydrogel polymer in the self-suspending proppant is at least 2 wt. %, at least 3 wt. %, at least 4 wt. %, at least 5 wt. %, at least 6 wt. %, at least 7 wt. %, or even at least 8 wt. %, based on the weight of the proppant substrate particle.

### Sandwich Structure

In accordance with this invention, self-suspending proppants with especially desirable properties are made by surface crosslinking both the inside surface and the outside surface of the hydrogel polymer coating of the proppant. As a result, this coating can be regarded as having a sandwich structure in which the inside surface of the coating, (i.e., the surface of the coating in contact with the proppant substrate particle) and the outside surface of the coating, (i.e., the surface of the coating remote from its inside surface) are independently surface crosslinked. Thus, the identity of the crosslinking agent used or the degree of crosslinking that has occurred, or both, at each surface of the coating will be different from the crosslinking that has occurred, if any, in the body section of the coating (i.e., the portion of the coating between its inside and outside surfaces). Meanwhile, the identity of the crosslinking agent used or the degree of crosslinking that has occurred, or both, at each surface of the coating can be different from one another or they can be the same.

### Crosslinking Agent

In order to carry out surface crosslinking in accordance with this invention, any di- or poly-functional crosslinking agent that has been previously used or may be used in the future for crosslinking the particular hydrogel polymer from which the hydrogel coating is made can be used. These crosslinking agents may be ionic or covalent, with covalent crosslinking agents being preferred. In addition, they may be in the form or polymers or oligomers or simple compounds (i.e., neither a polymer or oligomer). Desirably, these crosslinking agents will have number average molecular weights of ≤1,000,000 Daltons, ≤600,000 Daltons, ≤400,000 Daltons, ≤250,000 Daltons, or even ≤100,000 Daltons. Those with number average molecular weights of ≤75,000 Daltons, ≤50,000 Daltons, ≤40,000 Daltons, ≤30,000 Daltons, ≤20,000 Daltons, ≤10,000 Daltons, ≤7,000 Daltons and even ≤5,000 Daltons are especially interesting.

Examples of suitable crosslinking agents for use in this invention include organic compounds containing and/or capable of generating at least two of the following functional groups: epoxy, carboxy, aldehyde, isocyanate and amide. In some instances, especially when an anionic hydrogel polymer is being crosslinked, polyfunctional inorganic compounds such as borates, zirconates, silicas and their derivatives can also be used as can guar and its derivatives.

Specific examples of polyfunctional crosslinking agents that can be used in this invention include epichlorohydrin, polycarboxylic acids, carboxylic acid anhydrides such as maleic anhydride, carbodiimide, formaldehyde, glyoxal, glutaraldehyde, various diglycidyl ethers such as polypropylene glycol diglycidyl ether and ethylene glycol diglycidyl ether, other di- or polyfunctional epoxy compounds, phosphorous oxychloride, sodium trimetaphosphate and various di- or polyfunctional isocyanates such as toluene diisocyanate, methylene diphenyl diisocyanate, 1-ethyl-3-(3-dimethylaminopropyl) carbodiimide, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

The amount of crosslinking agent that can be used to surface cross link each of the inside surface and outside surface of the hydrogel polymer coating of the inventive self-suspending proppants can vary widely, and essentially any amount can be used. Generally speaking, the total amount of crosslinking agent that can be used to crosslink this hydrogel polymer coating as a whole will be about 1 to 50 wt. %, more typically about 1 to 40 wt. %, about 3 to 40 wt. %, about 3 to 25 wt. %, about 5 to 40 wt. %, about 5 to 25 wt. %, or even about 5 to 12 wt. %, based on the dry weight of the hydrogel polymer that is being crosslinked. In those embodiments of this invention in which the body section of the hydrogel coating is not crosslinked, 10-50%, 15-45%, 20-40% or even 25-35% of this crosslinking agent can be used to crosslink the inside surface of the hydrogel polymer coating, with the balance being used to crosslink the outside surface of this coating. In contrast, in those embodiments of this invention in which the body section of hydrogel polymer coating is also crosslinked, 5-30%, 10-25% or even 15-20% of the total amount of crosslinking agent can be used for crosslinking the inside surface of the hydrogel polymer coating, another 10-40%, 15-30% or even 20-25% is used for surface crosslinking the outside surface of the hydrogel polymer coating, with the balance being used to crosslink the outside surface of this coating.

### Substrate Reactive Crosslinking Agents

In an especially interesting embodiment of this invention, the crosslinking agent used to surface crosslink the inside surface of the hydrogel polymer coating is also capable of reacting with the proppant substrate particle on which this coating is applied. As a result, an especially strong bond can be produced between the two, thereby further enhancing the durability of the hydrogel coating that is formed.

For this purpose, any crosslinking agent which is capable of reacting with pendent moieties of the hydrogel polymer as well as pendant moieties of the proppant substrate particle can be used. Polyfunctional isocyanates (including diisocyanates) and polyfunctional epoxides (including diepoxides), such as those specifically named above, are preferred for this purpose, especially when the proppant substrate particle carries pendant hydroxyl groups such as occurs, for example, when conventional frac sand is used as the proppant substrate particle.

### Catalyst for Crosslinking Agent

In those embodiments of this invention in which the crosslinking agent used is covalent, a catalyst (also referred to as an “accelerator”) for this crosslinking agent can also be included in the system.

Common types of catalysts or accelerators for this purpose include acids such as different sulfonic acids and acid phosphates, tertiary amines such as triethylenediamine (also known as 1,4-diazabicyclo[2.2.2]octane), and metal compounds such as lithium aluminum hydride and organotin, organozirconate and organotitanate compounds. Examples of commercially available catalysts include Tyzor product line (Dorf Ketal); NACURE, K-KURE and K-KAT product lines (King Industries); JEFFCAT product line (Huntsman Corporation) etc. Any and all of these catalysts can be used.

If such a catalyst is used, it will normally be applied separately from its crosslinking agent. So, for example, when the inside surface of a hydrogel polymer coating layer is being crosslinked, the crosslinking agent and catalyst will normally be applied to the underlying substrate (e.g., the proppant substrate particle) separately, in either order, before the hydrogel polymer coating layer is applied. Similarly, when the outside surface of a hydrogel polymer coating layer is being crosslinked, the crosslinking agent and catalyst will also normally be applied to this outside surface separately, in either order. However, it is also possible to combine the catalyst and crosslinking agent together and then apply the mixture so formed to the underlying substrate, at least in those instances in which the reaction rate between the two is slow enough to allow the mixture to fully coat this underlying substrate before any significant reaction of the crosslinking agent occurs.

### Multiple Hydrogel Polymers

In some embodiments of this invention, the hydrogel coating may be formed from multiple hydrogel polymers. If so, all of these hydrogel polymers can be of the same type of hydrogel polymer or different types of hydrogel polymer. In this context, a “type” of hydrogel polymer will be understood to mean a cationic hydrogel polymer, an anionic hydrogel polymer and a nonionic hydrogel polymer. Thus, hydrogel polymer coatings made from combinations of different types of hydrogel polymers can be made including combinations of cationic hydrogel polymers and anionic hydrogel polymers, combinations of cationic hydrogel polymers and nonionic hydrogel polymers, combinations of anionic hydrogel polymers and nonionic hydrogel polymers, and combinations of cationic hydrogel polymers, anionic hydrogel polymers and nonionic hydrogel polymers.

When multiple hydrogel polymers are used, they can be mixed together before being combined with the proppant substrate particle, thereby producing a hydrogel coating in which these polymers are uniformly distributed in the coating. Alternatively, they can be applied to the proppant substrate particle sequentially, thereby producing a hydrogel coating in which they are distributed in the coating non-uniformly. Depending on how this is done, the coating obtained can be composed of distinct layers, each made from its own hydrogel polymer, or it can be composed of different regions in which the concentration of the first applied hydrogel polymer decreases while the concentration of the second applied hydrogel polymer increases from the inside surface of the coating to its outside surface.

Moreover, in those embodiments in which distinct layers are formed, each of these distinct layers can be surface crosslinked on both inside and outside surfaces in accordance with this invention or only some of these hydrogel polymer coating layers can be surface crosslinked in this way. In addition, some of these coating layers can be surfaced crosslinked on only one, not both, surfaces. In all cases, it is desirable that both the inside and outside surfaces of the hydrogel coating as a whole be surface crosslinked.

### Method of Manufacture

The inventive self-suspending proppants can be made in both batch operation, as illustrated in the following working examples, and continuously. In both instances, the hydrogel polymer or polymers used will normally be supplied in the form of an inverse emulsion, with the proppant substrate particle being serially coated with the different ingredients which form its hydrogel polymer coating.

For example, an inventive self-suspending proppant whose hydrogel polymer coating is composed of only a single homogeneous layer, whether composed of only a single hydrogel polymer or a homogenous mixture of two or more different hydrogel polymers, will normally be made by applying a first crosslinking agent to the proppant substrate particle for crosslinking the inside surface of the hydrogel polymer coating, followed by forming a polymer/particle mixture by combining the treated proppant particle substrate so made with an inverse emulsion of the hydrogel polymer or polymers forming the hydrogel coating with continued mixing. This combining step normally causes the inverse emulsion to break, the result of which is that the composition as whole becomes more viscous, the carrier liquids in the inverse emulsion begin evaporating and the hydrogel polymer or polymers in the emulsion begin depositing on the surfaces of the individual proppant substrate particles.

Continued mixing of this polymer/particle mixture causes evaporation of most of the remaining carrier liquid of the emulsion, with the remaining hydrogel polymer depositing on the individual proppant substrate particles as discrete, continuous coatings, thereby producing modified proppants. Normally, these modified proppants will then be dried, as further discussed below. In accordance with this invention, after this polymer/particle mixture is formed but before this drying step occurs, a second crosslinking agent is added to the polymer/particle mixture, thereby causing the outer surface of the hydrogel coating to crosslink. As indicated above, this second crosslinking agent may be the same as or different from the first crosslinking agent, both in terms of identity and amount used. In addition, if a catalyst for the first and/or second crosslinking agent is used, it can be applied before or after its crosslinking agent is applied.

Self-suspending proppants whose hydrogel polymer coatings are formed from multiple hydrogel polymers non-uniformly distributed in the hydrogel coating layers can be made in generally the same way, with the different hydrogel polymers being added sequentially to the proppant substrate particle.

### Drying the Proppant

The easiest way of making the inventive self-suspending proppants available commercially will be by manufacture in a central location and then transport in bulk to individual well sites. For this purpose, these proppants desirably should resemble conventional proppants in terms of bulk handling properties in the sense of being dry and free-flowing when stored and transported. In this context, “dry” will be understood to mean that these proppants have not been combined with a carrier liquid such as would occur if they were present in a fracturing fluid or other suspension or slurry. Preferably, the moisture content of the inventive self-suspending proppants will be no greater than 1 wt. %, 0.5 wt. % or even 0.1 wt. %. Meanwhile, “free-flowing” will be understood to mean that any clumping or agglomeration that might occur when these proppants are stored for more than a few days can be broken up by gentle agitation. Preferably, the inventive self-suspending proppants remain free-flowing after being subjected to a relative humidity of between about 80%-90% for one hour at 25-35° C.

In most instances, each ingredient used to form the inventive self-suspending proppants, i.e., the crosslinking agents, the catalysts and the hydrogel polymer, will be dissolved or dispersed (suspended, emulsified) in a suitable carrier liquid such as water or a low boiling organic solvent when supplied. Therefore, the manufacturing method will usually include some type of drying operation for removing these carrier liquids.

For this purpose, any type of drying operation can be used. Most conveniently, this can be done by contacting the proppants with flowing hot air while they are being gently agitated. While drying can be done after each ingredient is applied, or after each hydrogel coating layer is applied and surface crosslinked, normally it will be done only after all coating ingredients have been applied.

### Properties

The inventive self-suspending proppant, optionally but preferably, is free-flowing when dry. This means that any clumping or agglomeration that might occur when this proppant is stored for more than a few days can be broken up by moderate agitation. This property is beneficial in connection with storage and shipment of this proppant above ground, before it is combined with its aqueous fracturing fluid.

When deposited in its aqueous fracturing fluid, the inventive self-suspending proppant hydrates to achieve an effective volumetric expansion which makes it more buoyant and hence effectively self-suspending. In addition, it retains a significant portion of this enhanced buoyancy even if it is exposed to hard or salty water. Moreover, in some embodiments, it is also durable in the sense that it retains a substantial degree of its self-suspending character (i.e., its enhanced buoyancy) even after being exposed to substantial shear forces.

This enhanced buoyancy can be quantitatively determined by a Settled Bed Height Analytical Test carried out in the following manner: 35 g of the proppant is mixed with 85 ml of the aqueous liquid (e.g., preferably, water) to be tested in a glass bottle. The bottle is vigorously shaken for 1 minute, after which bottle is left to sit undisturbed for 5 minutes to allow the contents to settle. The height of the bed formed by the hydrated, expanded proppant is then measured using a digital caliper. This bed height is then divided by the height of the bed formed by the uncoated proppant substrate particle. The number obtained indicates the factor (multiple) of the volumetric expansion.

In accordance with this invention, the inventive proppant is desirably designed to exhibit a volumetric expansion, as determined by this Settled Bed Height Analytical test when carried out using simulated test waters having different levels of conductivities and hardness, as described in the following Table 1, of ≥˜1.3, ≥˜1.5, ≥˜1.75, ≥˜2, ≥˜2.25, ≥˜2.5, ≥˜2.75, ≥˜3, or even ≥˜3.5.

In this regard, it will be appreciated that a volumetric expansion of 2 as determined by this test roughly corresponds to cutting the effective density of the proppant in half. For example, if an inventive self-suspending proppant made from conventional frac sand exhibits a volumetric expansion of 2 according to this test, the effective density (i.e., the apparent specific gravity) of this frac sand will have been reduced from about 2.65 g/cc to about 1.4 g/cc. Persons skilled in the art will immediately recognize that this significant decrease in density will have a major positive effect on the buoyancy of the proppant obtained which, in turn, helps proppant transport in hydraulic fracturing applications tremendously, avoiding any significant proppant settlement during this time.

In terms of maximum volumetric expansion, persons skilled in the art will also recognize that there is a practical maximum to the volumetric expansion the inventive proppant can achieve, which will be determined by the particular type and amount of hydrogel-forming polymers used in each application.

Another feature of the inventive proppant is that its water-swellable composite coating rapidly swells when contacted with water. In this context, “rapid swelling” will be understood to mean that at least 80% of the ultimate volume increase that this coating will exhibit is achieved within a reasonable time after these proppants have been mixed with their aqueous fracturing liquids. Generally, this will occur within 8 to 12 minutes of the proppant being combined with its aqueous fracturing liquid, although it can also occur within 30 minutes, within 20 minutes, within 10 minutes, within 7.5 minutes, within 5 minutes, within 2.5 minutes or even within 1 minute of this time.

Still another feature of the inventive proppant is durability or shear stability. In this regard, it will be appreciated that proppants inherently experience significant shear stress when they are used, not only from pumps which charge the fracturing liquids containing these proppants downhole but also from overcoming the inherent resistance to flow encountered downhole due to friction, mechanical obstruction, sudden changes in direction, etc. The hydrogel polymer coatings of the inventive self-suspending proppants, although inherently fragile due to their hydrogel nature, nonetheless are durable enough to resist these mechanical stresses and hence remain largely intact (or at least associated with the substrate) until they reach their ultimate use locations downhole.

For the purposes of this invention, coating durability can be measured by a Shear Analytical Test in which the settled bed height of a proppant is determined in the manner described above after a mixture of 100 g of the proppant in 1 liter of water has been subjected to shear mixing at a shear rate of about 511 s⁻¹ for a suitable period of time, for example 5 or 10 minutes. The inventive self-suspending proppant desirably exhibits a volumetric expansion, as determined by the above Settled Bed Height Test, of at least about 1.3, more desirably about at least about 1.5, at least about 1.6, at least about 1.75, at least about 2, at least about 2.25, at least about 2.5, at least about 2.75, at least about 3, or even at least about 3.5 after being subjected to the above shearing regimen for 5 minutes using ordinary tap water as the test liquid.

Inventive self-suspending proppants which exhibit volumetric expansions of at least about 1.3, at least about 1.5, at least about 1.75, at least about 2, at least about 2.25, at least about 2.5, at least about 2.75 or even at least about 3 after having been subjected to the above shearing regimen for 10 minutes using the simulated test waters described in Table 1 below, are especially interesting.

In this regard, it is well known that calcium and other cations can substantially retard the ability of anionic hydrogel-forming polymers to swell. This problem can be particularly troublesome when self-suspending proppants made with such polymers are used, because the waters to which the proppants are exposed, including both the source water from which the associated fracturing fluid is made up as well as the geological formation water which the proppants encounter downhole, can often contain significant quantities of these ions.

This problem, i.e., the tendency of calcium and other cations to retard the ability of anionic hydrogel-forming polymers to swell, can begin to occur when the hardness of the water encountered by the polymer reaches levels as low as 300 ppm. In the context of this document, the “hardness” of a water sample means the sum of the concentrations of all divalent cations in the sample in terms of an equivalent weight of calcium carbonate. For example, a hardness of 1,000 ppm means that the total concentration of divalent cations in the sample is the same as the concentration of calcium cations that would be produced by 1,000 ppm by weight of CaCO₃ dissolved in pure water.

In many places in the United States especially where hydraulic fracturing may be practiced, municipal waters (i.e., the potable water produced by local municipalities) can have hardness levels of 300 ppm or more, while naturally-occurring ground waters can have hardness levels of 1,000 ppm or more. Meanwhile, sea water has a hardness of approximately 6,400 ppm, while the geological formation waters encountered downhole in many locations where hydraulic fracturing occurs can have hardness levels even as high as 40,000 ppm or even 80,000 ppm. Therefore, in the following working examples, Test waters (TW) 1, 2, 3 and 4 were formulated with varying amounts of CaCl₂, MgCl₂, NaCl and KCl to mimic the different types of aqueous liquids normally found in hydraulic fracturing, with Test water 1 being formulated to simulate sea water.

In addition to the above Shear Analytical Test, another means for assessing coating durability is a Viscosity Measurement Test in which the viscosity of the supernatant liquid that is produced by the above Shear Analytical Test is measured after the proppant has had a chance to settle. If the durability of a particular proppant is insufficient, an excessive amount of its water-swellable composite coating will come off and remain dissolved or dispersed in the supernatant liquid. The extent to which the viscosity of this liquid increases as a result of this dissolved or dispersed coating is a measure of the durability of the water-swellable composite coating. A viscosity of about 20 cPs or more indicates a low coating durability. Desirably, the viscosity of the supernatant liquid will be about 10 cPs or less, more desirably about 5 cPs or less.

### WORKING EXAMPLES

In order to more thoroughly describe this invention, the following working examples are provided. In these examples, self-suspending proppants made in accordance with this invention were tested for their ability to swell when exposed to different simulated test waters.

The properties of these test waters are set forth in the following Table 1:

TABLE 1
Properties of Test Waters (TW)

| | Properties of Each Test Water | | | | |
|---|---|---|---|---|---|
| | Fresh | | | | |
| Property | Water | TW 1 | TW 2 | TW 3 | TW 4 |
| pH | 6.5 | 5.8 | 5.7 | 5.8 | 6.2 |
| Conductivity, | 295 | 19,200 | 115,200 | 242,000 | 501,000 |
| μS | | | | | |
| Hardness, ppm | 120 | 6,400 | 6,400 | 6,400 | 40,000 |
| TDS*, ppm | <1,000 | 29,600 | 69,500 | 136,00 | 350,000 |

*Total Dissolved Solids

### Example 1—Anionic PAM/Cationic Starch Hybrid

1000 g of sand was added to the mixing bowl of a commercial Kitchen Aid mixer. 1 g of a 5% PEG-DGE (polyethylene glycol diglycidyl ether) solution in ethylene glycol:water (5:95) was then added, and the mixture obtained was mixed for an additional 1 minute at speed setting 2 of the machine (about 70 rpm).

25.2 g of a commercially available anionic polyacrylamide invert emulsion containing approximately one third by weight organic solvent, one third water and one third of an anionic polyacrylamide polymer made by copolymerizing acrylamide and acrylic acid was used to form the first coating of the self-suspending proppants of this example. This was done by thoroughly mixing this anionic polyacrylamide invert emulsion with 2.8 of glycerol and then adding the mixture so formed to the treated sand in the mixing bowl, with further mixing for 3.5 minutes at a speed setting of 2.

30 g of a 40% aqueous dispersion of a commercially available cationic starch was then used to form the second hydrogel polymer coating of the self-suspending proppants of this example. This was done by adding this starch dispersion to the contents of the mixing bowl, followed by adding 6.4 g of PPGDGE (polypropylene glycol diglycidyl ether) as a crosslinking agent for the starch and 16 g of 5M NaOH as a catalyst for the PPGDGE, with continued mixing for an additional 5 minutes at speed setting 3 of the machine. The mixture so obtained was then transferred to a fluidized bed dryer and dried for not more than 5 minutes at 90° C. at 38 rpm.

A number of different runs were made including a control run in which no cationic starch was used. In some cases the partially dried mixture obtained above was transferred back to the Kitchen Aid mixing bowl and further mixed with 2.5 g of a p-MDI covalent crosslinking agent for 2 minutes at speed 2, followed by 2 g of 20% aqueous solution of a tertiary amine catalyst for the p-MDI and mixed for 1.5 minutes at speed 2. In all cases the mixture was transferred into an aluminum foil tray and further dried for 30 minutes at 90° C. in a convection oven to obtain a free flowing coated proppant. Several coatings were made using varying amounts of anionic polyacrylamide emulsion and cationic starch dispersion, keeping all other ingredients the same.

The proppants obtained were then tested using the Settled Bed Height analytical test described above to determine their ability to swell when contacted with the test waters described in Table 1.

The composition of each proppant tested and the results obtained are shown in the following Table 2:

TABLE 2
Composition and Swelling Ability of Proppants of Example 1

| | Proppant Composition, wt % (dry), | | | | | |
|---|---|---|---|---|---|---|
| | based on weight of sand substrate | | | | | |
| | Control | Run 1 | Run 2 | Run 3 | Run 4 | Run 5 |
| Anionic | 0.91 | 0.91 | 0.45 | 1.19 | 1.44 | 1.44 |
| Polyacrylamide | | | | | | |
| Cationic starch | 0 | 1.20 | 2.00 | 1.60 | 1.32 | 1.32 |
| Total hydrogel | 0.91 | 2.11 | 2.45 | 2.79 | 2.76 | 2.76 |
| PPGDGE | 0 | 0.68 | 0.68 | 0.68 | 0.68 | 0.68 |
| NaOH | 0 | 0.32 | 0.32 | 0.32 | 0.32 | 0.32 |
| pMDI | 0.25 | 0.25 | 0.25 | 0.25 | 0 | 0.25 |
| catalyst | 0.04 | 0.04 | 0.04 | 0.04 | 0 | 0.04 |

Performance Testing--Swelling %

| | | | | | | |
|---|---|---|---|---|---|---|
| Fresh water | 400 | 400 | 400 | 400 | 400 | 400 |
| TW 1 | 10 | 90 | 70-80 | 110-120 | 100 | 100 |
| TW 2 | 10 | 90 | 70-80 | 110-120 | 100 | 100 |
| TW 3 | 10 | 90 | 70-80 | 110-120 | 100 | 100 |
| TW 4 | 10 | 90 | 70-80 | 110-120 | 100 | 100 |

As can be seen from Table 2, all proppants exhibited substantial swelling when exposed to fresh water. However the control proppant, which was made with no cationic starch, exhibited very little swelling when exposed to all four different test waters. On the other hand, all five of the inventive proppants exhibited substantial swelling in different test waters, even though they were made with comparatively little amounts of hydrogel polymer in total.

### Example 2 Cationic PAM/Anionic Starch Hybrid

Example 1 was repeated except that a commercially available cationic polyacrylamide invert emulsion containing approximately one third polymer, one third organic solvent and one third water was used to form the first coating on the sand substrate particles, while a 40% aqueous dispersion of a commercially available anionic starch was used to form the second hydrogel polymer coating.

The composition of each proppant tested and the results obtained are shown in the following Table 3:

TABLE 3
Composition and Swelling Ability of Proppants of Example 2

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| Cationic | 0.63 | 0.31 | 0.83 | 1.00 | 1.00 |
| Polyacrylamide | | | | | |
| Anionic starch | 1.20 | 2.00 | 1.60 | 1.32 | 1.32 |
| Total hydrogel | 1.83 | 2.31 | 2.43 | 2.32 | 2.32 |
| PPGDGE | 0.68 | 0.68 | 0.68 | 0.68 | 0.68 |
| NaOH | 0.32 | 0.32 | 0.32 | 0.32 | 0.32 |
| pMDI | 0.25 | 0.25 | 0.25 | 0.25 | 0 |
| catalyst | 0.04 | 0.04 | 0.04 | 0.04 | 0 |

Performance Testing -- Swelling %

| | | | | | |
|---|---|---|---|---|---|
| TW 1 | 60 | 70-80 | 80 | 90 | 90 |
| TW 2 | 60 | 70-80 | 80 | 90 | 90 |
| TW 3 | 60 | 70-80 | 80 | 90 | 90 |
| TW 4 | 60 | 70-80 | 80 | 90 | 90 |

As can be seen from Table 3, all five of the inventive proppants exhibited substantial swelling in these different test waters, even though they were also made with comparatively little amounts of hydrogel polymer in total.

### Example 3 Anionic PAM/Cationic PAM Hybrid

Examples 1 and 2 were repeated, except that the first hydrogel polymer coating was formed from a commercially available anionic polyacrylamide invert emulsion while the second hydrogel polymer coating was formed from a commercially available cationic polyacrylamide invert emulsion. Two different commercially available anionic polyacrylamide invert emulsions were used for this purpose, both of which were formulated from polyacrylamide polymers made by copolymerizing acrylamide with acrylic acid or an acrylic acid salt. Similarly, two different commercially available cationic polyacrylamide emulsions were used for this purpose.

The composition of each proppant tested and the results obtained are shown in the following Table 4:

TABLE 4
Composition and Swelling Ability of Proppants of Example 3

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| 1st Cationic | 0 | 0 | 0.72 | 1.08 | 1.08 |
| Polyacrylamide | | | | | |
| 2nd Cationic | 0.99 | 0.99 | 0 | 0 | 0 |
| Polyacrylamide | | | | | |
| 1st Anionic | 0 | 0 | 0 | 0 | 0.83 |
| Polyacrylamide | | | | | |
| 2nd Anionic | 0.99 | 0.66 | 0.50 | 0.50 | 0 |
| Polyacrylamide | | | | | |
| Total hydrogel | 1.98 | 1.65 | 1.22 | 1.58 | 1.91 |
| pMDI | 0.25 | 0.25 | 0.25 | 0.25 | 0.25 |
| Catalyst | 0.4 | 0.4 | 0.4 | 0.4 | 0.4 |

Performance Testing -- Swelling %

| | | | | | |
|---|---|---|---|---|---|
| TW 1 | 80 | 40 | 30 | 40 | 70 |
| TW 2 | 80 | 40 | 30 | 40 | 70 |
| TW 3 | 80 | 40 | 30 | 40 | 70 |
| TW 4 | 80 | 40 | 30 | 40 | 70 |

As can be seen from Table 4, all five of the inventive proppants exhibited at least some significant degree of swelling in these different test waters, even though they were made with very small amounts of hydrogel polymer in total.

### Example 4 Hydrolyzed Anionic PAM/Cationic PAM Hybrid

1000 g of sand was added to the mixing bowl of a commercial Kitchen Aid mixer. In some runs, 2 g of a 5% PEG-DGE (polyethylene glycol diglycidyl ether) solution in ethylene glycol:water (5:95) was then added, followed by mixing for an additional 1 minute at speed setting 2 of the machine (about 70 rpm). In other runs, 1 g of a glycol:water (5:95) mixture was used for this purpose.

A suitable amount, for example, 12.1 g, of a commercially available anionic polyacrylamide invert emulsion was mixed with a suitable amount, for example, 48.3 g, of a commercially available cationic polyacrylamide invert emulsion. The mixture so obtained was then added to the mixing bowl containing the previously treated sand, with continued mixing for an additional 3.5 minutes at a speed setting of 2. 2.5 g of a p-MDI covalent crosslinking agent was then added with mixing for an additional 2 minutes at speed setting 2, followed by the addition of 2 g of a 20% aqueous solution of a tertiary amine catalyst for the p-MDI, with mixing for an additional 1.5 minutes at speed setting 2. In all cases the mixture was transferred to a fluid bed dryer and further dried for 7 to 10 minutes at 90° C. and 38 rpm, to obtain a dry, free flowing coated proppant.

Five different self-suspending proppants were made using varying amounts of anionic and cationic polyacrylamide emulsions, keeping all other ingredients the same. In Runs 1, 2, 3 and 5, the anionic polyacrylamides used were hydrolyzed polyacrylamide having different degrees of hydrolysis (charge density) ranging from 10 to 90 mole %, more typically 10 to 60 mole %, 15 to 50 mole %, or even 20 to 40 mole %. Meanwhile, in Run 4 the anionic polyacrylamides used was made by copolymerization of acrylamide and acrylic acid or an acrylic acid salt.

The proppants obtained were then tested using the Settled Bed Height analytical test described above to determine their ability to swell when contacted with the test water described in Table 1.

The composition of each proppant tested and the results obtained are shown in the following Table 5:

TABLE 5
Composition and Swelling Ability of Proppants of Example 4

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| 1st Cationic | 2.46 | 2.05 | 1.85 | 1.54 | 0 |
| Polyacrylamide | | | | | |
| 2nd Cationic | 0 | 0 | 0 | 0 | 2.09 |
| Polyacrylamide | | | | | |
| 1st Anionic | 0.45 | 0.37 | 0 | 0 | 0 |
| Polyacrylamide | | | | | |
| 2nd Anionic | 0 | 0 | 0.72 | 0 | 0 |
| Polyacrylamide | | | | | |
| 3rd Anionic | 0 | 0 | 0 | 1.42 | 0 |
| Polyacrylamide | | | | | |
| 4th Anionic | 0 | 0 | 0 | 0 | 0.57 |
| Polyacrylamide | | | | | |
| Total hydrogel | 2.91 | 2.43 | 2.57 | 2.96 | 2.66 |
| pMDI | 0.25 | 0.25 | 0.25 | 0.25 | 0.25 |
| catalyst | 0.02 | 0.02 | 0.02 | 0.02 | 0.02 |

Performance Testing -- Swelling %

| | | | | | |
|---|---|---|---|---|---|
| TW1 | 175 | 145 | 145 | 140 | 125 |
| TW4 | 150 | 130 | 115 | 96 | 125 |

As can be seen from Table 4, all five of the inventive proppants exhibited a significant degree of swelling in different test waters, even though they were made with very small amounts of hydrogel polymer in total. In addition, by comparing Run 4 with the Runs 1, 2, 3 and 5, it can be seen that the inventive self-suspending proppants made with hydrolyzed anionic polyacrylamide exhibit exceptionally good tolerance to waters with very high salt contents.

### Example 5 Anionic PAM/Nonionic Starch

1000 g of 50° C. pre-heated sand was added to the mixing bowl of a commercial Kitchen Aid mixer. In some runs, 2 g of a 5% PEGDGE (polyethylene glycol diglycidyl ether) solution in ethylene glycol:water (5:95) was then added, followed by mixing for an additional 1 minute at speed setting 2 of the machine (about 70 rpm). In other runs, 1 g of a glycol:water (5:95) mixture was used for this purpose.

A suitable amount of the same anionic polyacrylamide invert emulsion used in Example 1 was added to the mixing bowl, after which a suitable amount of a commercially available nonionic starch, in particular a pre-crosslinked, cold water swellable modified waxy maize starch, was added and the mixture so obtained mixed for an additional 3.5 minutes at speed setting 2 of the machine. In some runs, the anionic polyacrylamide invert emulsion contained 10 wt. % glycerol based on the combined weight of the glycerol and emulsion, while in other runs it did not. In addition, in some runs, the pre-crosslinked, cold water-swellable maize starch was added in powder form, as received from the manufacturer, while in other runs it was added in the form of a 60 wt. % dispersion in either IPA (isopropyl alcohol) or a water-white commercially available isoparaffinic organic solvent (Isopar G).

Then 1.25 g of a p-MDI crosslinking agent was added with continuous mixing for 2 minutes at speed setting 2, followed by the addition of 1 g of a 20% aqueous solution of a tertiary amine catalyst for the p-MDI, followed by additional mixing for 1.5 minute at speed setting 2. Various amounts of water were then sprayed into the mixing bowl, following which the mixture was transferred to a fluidized bed dryer and dried for 5 minutes at 90° C. at 38 rpm to obtain a free flowing coated proppant.

Several coatings were made using varying amounts of different components to obtain optimum performance.

The proppants obtained were then tested using the Settled Bed Height analytical test described above to determine their ability to swell when contacted with the test waters described in Table 1.

The composition of each proppant tested and the results obtained are shown in the following Table 6:

TABLE 6
Composition and Swelling Ability of Proppants of Example 5

| | Proppant comp, wt % (dry), based on weight of sand substrate | | | | | |
|---|---|---|---|---|---|---|
| | Run 1 | Run 2 | Run 3 | Run 4 | Run 5 | Run 6 |
| Pretreat Sand w PEGDE | No | No | Yes | Yes | Yes | No |
| EG in Anionic PAM Emulsion | Yes | Yes | No | No | No | Yes |
| Anionic PAM, wt, % | 1.2 | 1.2 | 1.2 | 1.2 | 1.2 | 1.2 |
| Nonionic starch, wt, % | 3.1 | 3.1 | 3.1 | 3.1 | 3.1 | 3.1 |
| Total Hydrogel, wt. % | 4.3 | 4.3 | 4.3 | 4.3 | 4.3 | 4.3 |
| Form of Nonionic Starch | IPA disp | Iso-G disp | Iso-G disp | IPA disp | powder | IPA disp |
| Amount of Water Spray, g | 12.88 | 12.88 | 12.88 | 12.88 | 13.92 | 12.88 |
| % Swelling, TW 1 | 155 | 120 | 120 | 155 | 125 | 155 |
| % Swelling, TW 4 | 115 | 100 | 100 | 130 | 90 | 105 |

As can be seen from Table 6, all five of the inventive proppants exhibited a significant degree of swelling in different test waters, even though they were made with small amounts of hydrogel polymer in total.

### Example 6 Anionic PAM/Cationic PAM/Nonionic Modified Starch Hybrid

Example 4 was repeated, except that 5-100% wt. % of a nonionic starch, based on the combined weights of the anionic/cationic polyacrylamide mixture used, was also used to make the hydrogel coating of these proppants. In some runs, the nonionic starch was premixed with a mixture of the anionic and cationic polyacrylamide dispersions. In other runs, each of these hydrogel polymers was separately added so that three separate hydrogel coating layers were formed, with the nonionic starch coating layer comprising either the first, second or third coating layer. Also, in some instances, the nonionic modified starch was added in the form of a powder, while in other instances it was added in the form of an aqueous dispersion. In addition, in those instances in which the nonionic modified starch was added in the form of a powder, various amounts of water were then sprayed into the mixing bowl, as described in the above Example 5.

The composition of each proppant tested and the results obtained are shown in the following Table 7:

TABLE 7
Composition and Swelling Ability of Proppants of Example 6

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| Cationic | 1.51 | 1.51 | 0.95 | 1.51 | 0.95 |
| Polyacrylamide | | | | | |
| Anionic | 0.29 | 0.29 | 0.18 | 0.29 | 0.18 |
| Polyacrylamide | | | | | |
| Nonionic Modified | 0.21 | 0.71 | 2.52 | 0.10 | 2.52 |
| Starch | | | | | |
| Total hydrogel | 2.01 | 2.51 | 3.65 | 1.90 | 3.65 |
| pMDI | 0.12 | 0.12 | 0.12 | 0.12 | 0.12 |
| catalyst | 0.02 | 0.02 | 0.02 | 0.02 | 0.02 |
| Form of Starch | Powder | Powder | Powder | Aq. disp. | Powder |
| Amount of Water | 1.65 | 5.51 | 9.84 | 0 | 9.84 |
| Spray, g | | | | | |

Performance Testing -- Swelling %

| | | | | | |
|---|---|---|---|---|---|
| Swelling % in TW1 | 125 | 125 | 115 | 140 | 110 |
| Swelling % in TW4 | 110 | 110 | 105 | 110 | 105 |

As can be seen from Table 7, all five of the inventive proppants exhibited a significant degree of swelling in different test waters, even though they were made with relatively small amounts of hydrogel polymer in total.

### Example 7 Cationic PAM/Nonionic Modified Starch Hybrid

Example 1 was repeated except that a commercially available cationic polyacrylamide invert emulsion containing approximately one third polymer, one third organic solvent and one third water was used to form the first coating on the sand substrate particles, while an aqueous dispersion of a commercially available nonionic modified starch was used to form the second hydrogel polymer coating in some runs (Run 2 through Run 4), while another nonionic modified starch aqueous dispersion or powder was used to form the second hydrogel layer in other runs (Run 5 through Run 7). In those instances in which a nonionic modified nonionic starch in powder form was used, the powder was added after the first coating or was mixed with the cationic hydrogel polymer first and then coated onto substrate. One experiment was also carried out without any nonionic starch coating (Run 1).

The composition of each proppant tested and the results obtained are shown in the following Table 8:

TABLE 8
Composition and Swelling Ability of Proppants of Example 7

| | Proppant Composition, wt % (dry), | | | | | | |
|---|---|---|---|---|---|---|---|
| | based on weight of sand substrate | | | | | | |
| | Run 1 | Run 2 | Run 3 | Run 4 | Run 5 | Run 6 | Run 7 |
| Cationic Polyacrylamide | 2.3 | 2.3 | 2.6 | 2.6 | 2.3 | 2.6 | 2.6 |
| Nonionic modified starch | 0 | 1.6 | 2.3 | 3.3 | 0.21 | 1.5 | 2.4 |
| Total hydrogel | 2.3 | 3.9 | 4.9 | 5.9 | 2.51 | 4.1 | 5.0 |
| PPGDGE | 0 | 0.68 | 0.68 | 0.68 | 0 | 0 | 0 |
| NaOH (5M) | 0 | 1 | 1 | 1 | 0 | 0 | 0 |
| pMDI | 0.25 | 0.25 | 0.25 | 0.25 | 0.25 | 0.25 | 0.25 |
| Catalyst | 0.02 | 0.02 | 0.02 | 0.02 | 0.02 | 0.02 | 0.02 |
| Form of the Starch | N/A | disp | disp. | disp. | Powder | Powder | disp. |

Performance Testing-Swelling %

| | | | | | | | |
|---|---|---|---|---|---|---|---|
| TW 1 | 160 | 85 | 100 | 120 | 130 | 140 | 160 |
| TW 4 | 130 | 75 | 90 | 110 | 120 | 130 | 150 |

As can be seen from Table 8, all of the inventive proppants exhibited varying degrees of swelling in different test waters, even though they were also made with comparatively little amounts of hydrogel polymer in total.

Although only a few embodiments of this invention have been described above, it should be appreciated that many modifications can be made without departing from the spirit and scope of the invention. All such modifications are intended to be included within the scope of this invention, which is to be limited only by the following claims:

1. A self-suspending proppant comprising a proppant substrate particle and a water-swellable coating made from a hydrogel polymer on the proppant substrate particle, wherein the water swellable coating defines an inside surface on the proppant substrate particle, an outside surface remote from the inside surface and a body section therebetween, wherein both the inside surface and the outside surface have been surface crosslinked.

2. The self-suspending proppant of claim 1, wherein the inside surface is crosslinked by a first crosslinking agent and the outside surface is crosslinked by a second crosslinking agent, and further wherein the number average molecular weights of both the first crosslinking agent and the second crosslinking agent are ≤1,000,000 Daltons.

3. The self-suspending proppant of claim 2, wherein the inside surface is crosslinked by applying a crosslinking agent to the proppant substrate particle and thereafter coating the proppant substrate particle with the hydrogel polymer.

4. The self-suspending proppant of claim 2, wherein the body section is also crosslinked.

5. The modified proppant of claim 2, wherein each of the inside surface and the outside surface are surface crosslinked by means of a covalent crosslinking agent which is independently selected from an epoxide, an anhydride, an aldehyde, a diisocyanate and a carbodiimide.

6. The self-suspending proppant of claim 5, wherein each covalent crosslinking agent is independently selected from an epoxide and a diisocyanate

7. The self-suspending proppant of claim 2, wherein the water swellable coating is formed from a polyacrylamide, a starch or both.

8. The self-suspending proppant of claim 2, wherein the modified proppant is made by (a) forming a polymer/particle mixture by combining an inverse emulsion of the hydrogel polymer with a proppant substrate particle that had previously been coated with a first covalent crosslinking agent, (c) continuing to mix the polymer/particle mixture until the hydrogel polymer coating is formed, and (d) drying the hydrogel polymer coating,
wherein a second covalent crosslinking agent is combined with the polymer/particle mixture before the hydrogel polymer coating is dried.

9. The self-suspending proppant of claim 2, wherein the hydrogel coating is made from a single hydrogel polymer.

10. The self-suspending proppant of claim 2, wherein the hydrogel coating is made from multiple different hydrogel polymers.

11. The self-suspending proppant of claim 10, wherein the hydrogel coating is formed from distinct coating layers, each coating layer being made from its own individual hydrogel polymer.

12. The self-suspending proppant of claim 10, wherein the hydrogel coating defines different regions in which the concentration of a first hydrogel polymer decreases while the concentration of a second hydrogel polymer increases from the inside surface of the coating to its outside surface.

13. The self-suspending proppant of claim 2, wherein the modified proppant exhibits a volumetric expansion of at least about 1.3 after being exposed to a simulated hard water containing 6,400 ppm hardness.

14. The self-suspending proppant of claim 13, wherein the modified proppant exhibits a volumetric expansion of at least about 1.75 after being exposed to a simulated hard water containing 6,400 ppm hardness.

15. The self-suspending proppant of claim 2, wherein the modified proppant exhibits a volumetric expansion of at least about 1.3 after having been subjected to shear mixing in a simulated hard water containing 6,400 ppm hardness at a shear rate of about 511 s⁻¹ for 10 minutes.

16. The self-suspending proppant of claim 15, wherein the modified proppant exhibits a volumetric expansion of at least about 1.75 after having been subjected to shear mixing in a simulated hard water containing 6,400 ppm hardness at a shear rate of about 511 s⁻¹ for 10 minutes.

17. The self-suspending proppant of claim 2, wherein the proppant is dry.

18. An aqueous fracturing fluid comprising an aqueous carrier liquid and the self-suspending proppant of claim 1.

19. A method for fracturing a geological formation comprising pumping the fracturing fluid of claim 18 into the formation.
